(19) United States
(12) Patent Application Publication
(10) Pub. No.: US 2005/0088521 A1
(43) Pub. Date: Apr. 28, 2005

(54) In-car video system using flash memory as a recording medium

(75) Inventors: Louis W. Blanco, Boonton, NJ (US); Leo Lorenzetti, Hardyston, NJ (US)

Correspondence Address: MAYER, FORTKORT & WILLIAMS, PC, 251 NORTH AVENUE WEST, 2ND FLOOR, WESTFIELD, NJ, 07090, US

(73) Assignee: Mobile-Vision Inc., Boonton, NJ (US)

(21) Appl. No.: 10/691,483

(22) Filed: Oct. 22, 2003

(51) Int. Cl. H04N 7/18

(52) U.S. Cl. 348/148

(57) ABSTRACT

An inventive system and method is provided by an in-car video system that uses a type of electrically erasable programmable read-only memory known as flash memory to store video of an incident or event. In an illustrative embodiment of the invention, a digital video recorder and video camera are fixably mounted in a vehicle such as a police cruiser. An event of interest is captured by a camera and the resulting video stream is converted into a form that writable to a flash memory. The video recorder writes the video to flash memory to thereby store a record of the event on the flash memory as a storage medium.

### BACKGROUND OF THE INVENTION

This invention is related generally to surveillance systems, and more particularly to an in-car video system using flash memory as a recording medium.

Vehicle-mounted surveillance systems, also termed in-car video systems, are seeing increased use in the security industry and law enforcement community as an effective means to provide an indisputable video and audio record of encounters involving officers and citizens. In these systems, a video camera is typically mounted on the police car's dashboard or windshield and is generally arranged to have a field of view of the area to the immediate front of the car. The field of view approximately corresponds to what an officer would see when seated in the car's front seat.

The video camera is operably coupled to a video recorder, such as a video cassette recorder (“VCR”) or digital video recorder (“DVR”), mounted in the police car, often in the trunk. A video recording may be started manually by the officer, or in some systems, the video recording is started automatically when, for example, the officer activates the police car's emergency systems (such as overhead lights and/or sirens), or when a vehicle speed-measuring radar unit is operated.

In-car video systems serve to enhance prosecution of traffic, DWI/DUI and controlled dangerous substances offenses (to name just a few) by contributing detailed graphical and auditory evidence in a time-sequential manner that is inherently unbiased and objective. Such evidence is a valuable adjunct to eyewitness and officer testimony. In addition, as with other quality-improvement initiatives where conduct is surveyed and recorded, in-car video system usage has been shown to assist in the maintenance of high professional standards among law enforcement personnel. Police-community relations have improved and citizen complaints of police misconduct have lessened in many jurisdictions where in-car video systems are used, often as a result of the inherently high-quality evidence provided by such systems. Videos taken with in-car video systems are also valuable training aids to law enforcement personnel.

Video evidence is protected (and the evidentiary chain of custody readily established) because the video recorder and video recording medium (i.e., videotape or hard disk drive) are typically “locked”, often both mechanically and electronically, within a tamperproof security enclosure in the car that is only accessible by law enforcement command personnel. In addition, the in-car systems are configured to prevent erasure or over-recording of a recorded encounter to ensure the integrity of the video evidence. In-car video systems may superimpose time and date stamps on the recorded video image as a further enhancement to the evidentiary strength of the videotape.

In-car video systems generally employ a wireless microphone carried on the person of a law enforcement officer to record an audio soundtrack that accompanies the visual scene captured on videotape. In some systems, additional wired microphones may be deployed in other locations within the car, such as the rear-seat passenger area, to record sounds and conversations emanating from those locations.

While current in-car video systems perform very well in many applications, recording media currently used with in-car video systems, including analog video tape and digital storage media like hard disk drives, are bulky and may present storage and other logistical issues in managing the recording media. The size of recording media and associated video recorders can present space utilization issues in some vehicle models as well.

Current recording media is subject to failure from physical damage to the media or degradation due to environmental factors such as heat, moisture and humidity. For example, hard disk drives can fail in a number of ways but mainly due to mechanical failures relating to the mechanics of the disk such as motor burnout or “stuck” bearings.

Head and head assembly failures represent another failure mode and include head crashes and read or write errors to the magnetic media. In analog systems, videocassettes can fail if carelessly handled or abused, for example, through tape breakage, stretching or fraying, image dropouts from deteriorated tape base films or magnetic coatings, and failure of tape transports.

### SUMMARY OF THE INVENTION

An inventive system and method is provided by an in-car video system that uses a type of electrically erasable programmable read-only memory known as flash memory to store video of an incident or event.

In an illustrative embodiment of the invention, a digital video recorder and video camera are fixably mounted in a vehicle such as a police cruiser. An event of interest is captured by a camera and the resulting video stream is converted into a form that is writable to a flash memory. The video recorder writes the video to flash memory to thereby store a record of the event on the flash memory as a storage medium. The type of flash memory preferentially used in the illustrative embodiment of the invention is known as a CompactFlash card.

Advantageously, the invention creates a robust in-car video system having a large amount of video storage combined with enhanced system packaging that is enabled through the very small form factor of the flash memory. Since flash memory is a solid state device using no moving parts, (i.e., the memory relies on the use of electronics instead of mechanical systems) it is inherently reliable.

Flash memory may endure extreme temperatures and retains data even without a continuously applied power source. Users may easily insert and remove flash memory from the video recorder and store additional flash memory card in the vehicle in a small amount of space. Because of its extremely small size, flash memory provides efficient and dense storage and is ideal as a removable media for archiving video recordings in a storage area away from the vehicle. The use of flash memory as the recording media may also help to reduce the costs of maintaining in-car video systems because relatively fragile and complex VCRs and DVRs are eliminated from the inventive in-car video system.

### BRIEF DESCRIPTION OF THE DRAWINGS

FIG. 1 is a simplified functional block diagram of an illustrative arrangement of the present invention depicting an in-car video system (including a windshield mounted camera, a control head, and trunk-mounted digital video recorder) in accordance with the invention; and

FIG. 2 is a flowchart illustrating a method of operating an in-car video system in accordance with the invention.

### DETAILED DESCRIPTION

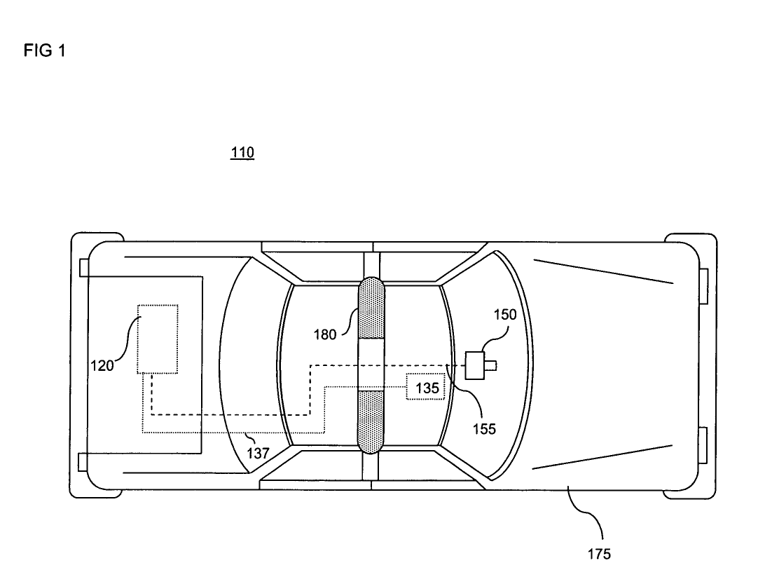

Referring to FIG. 1, there is depicted a simplified functional block diagram of an illustrative arrangement of the present invention depicting an in-car video system 110 (including a windshield mounted camera 150, a control head 135 and a trunk-mounted digital video recorder 120). Vehicle 175 is depicted in FIG. 1 as a police cruiser with emergency lightbar 180, however it is emphasized that the features and benefits of the present invention may be equally applicable to a wide variety of vehicle types, and further that the invention is not limited to law enforcement applications. Applications of the invention to the security and the transportation industries may be readily made, for example.

Camera 150 may be selected from the wide variety of available cameras. Preferably, camera 150 is a compact camera (to reduce the likelihood of obstructing the officer's view out the windshield) with color capabilities such as a solid-state CCD (“charge-coupled device”) camera that can operate in low-light environments. Camera 150 may be optionally configured with digital and/or optical zoom capabilities. Camera 150, in this illustrative arrangement, is mounted to the windshield of vehicle 175, however other mounting locations may be used in other applications. Camera 150 is operably coupled to digital video recorder 120 via bus 155.

A remote control head 135 is located in vehicle 175 near the driver and is operably coupled to digital video recorder 120 via bus 137 to allow the digital video recorder 120 to be conveniently controlled by the officer from within the vehicle. Remote control head 135 may be arranged with typical controls such as “POWER”, “RECORD”, “STOP”, “BACK”, “PLAY”, and “FORWARD” buttons which operate the digital video recorder 120 accordingly.

Digital video recorder 120, as shown in FIG. 1, may be located in secure enclosure (i.e., a “vault”) contained in the trunk of the car. The enclosure is generally quite rugged, both to provide deterrents against tampering or improper access to the video recording medium and also to protect the medium in the event that the vehicle 175 is involved in a crash. The enclosure may also be environmentally controlled to keep the digital video recorder 120 and recording medium within acceptable operating conditions.

It is emphasized that digital video recorder 120 may be conveniently located in other areas of the vehicle depending on the requirements of the application of the invention. As described in more detail below, the digital video recorder 120 is adapted to read and write to flash memory (which is has a small physical form factor compare with conventional storage media). Therefore, the invention enables more freedom in packaging the digital video recorder 120 so that it can occupy smaller volumes or be arranged in configurations that are better adapted to available space in the vehicle. For example, many vehicles used in police applications have the radio (i.e., sound system) that is sized for what is commonly called a “double DIN” opening (roughly 4″ high by 7″ wide). Other vehicles use smaller radios that fit within single DIN or 1.5 DIN openings. In all cases, the digital video recorder of the present invention is contemplated to be small enough to replace the factory radio. This may afford greater ease of operation in many applications and reduce or eliminate the need to place in-car video system components in the trunk of the vehicle. In addition to the digital video recorder 120, other in-car video system components such as the control head 135 and a video monitor (not shown in FIG. 1) may be integrated with the digital video recorder 120 to form a unitary system that is mounted in the space normally reserved for the radio in the vehicle.

Digital video recorder 120 is specifically adapted, in accordance with the invention, to record to non-volatile memory, including electrically erasable programmable read-only memory. Pronounced “double-e-prom” or “e-e-prom,” an EEPROM is a special type of programmable read-only memory (“PROM”) that can be erased by exposing it to an electrical charge. Like other types of PROM, EEPROM retains its contents even when the power to it is discontinued. Particular advantage may be realized in many applications of the invention by using “flash memory” which is a special type of EEPROM that can be erased and reprogrammed in blocks instead of one byte at a time. This feature makes flash memory generally “faster” than other types of non-volatile memories. In accordance with the invention, flash memory is well suited to in-car video system applications as a result of this fast speed at which data can be stored and accessed.

In the present illustrative embodiment of the invention, a flash memory embodied in a card-type format is utilized because such flash memory cards are designed to be conveniently installed and removed from devices that use them. Flash memory cards are typically rugged, durable and long lasting. They can withstand wide temperature ranges as well as high levels of shock and vibration. Many flash memory cards may be configured to provide data access speeds that are as fast or faster than hard disk drives and can support the recording of full motion video. Several types of flash memory cards are in use today including CompactFlash, Smart Media, Secure Digital, Multimedia Card, xD-Picture Card and Memory Stick. While all such flash memory cards can be used successfully to facilitate the practice of the invention, the CompactFlash card provides many significant benefits and is preferred in many applications.

CompactFlash consists of a small circuit board with flash-memory chips and a dedicated built-in controller chip, all encased in a exterior shell that is several times thicker than other flash memory cards. CompactFlash cards are 43 mm wide and 36 mm long, and come in two thicknesses: Type I cards are 3.3 mm thick, and Type II cards are 5.5 mm thick. CompactFlash cards support dual voltage and will operate at either 3.3 volts or 5 volts. The extra thickness of CompactFlash cards provides enhanced storage capacity over other flash memory cards. Currently, the developer of CompactFlash cards, SanDisk, is producing a Type I CompactFlash card with 4 gigabytes of storage capacity. Such flash memory capacity can provide many hours of full motion video storage per flash memory card (where the exact number of hours of video storage will depend on the image size, resolution, frame rate and other factors associated with the video). CompactFlash cards are available in speeds that can provide sustained write performance at a level sufficient to support digital recording of full-motion video. Of course, other lower capacity flash memory cards may also be used with great effect as required by the specific application of the invention.

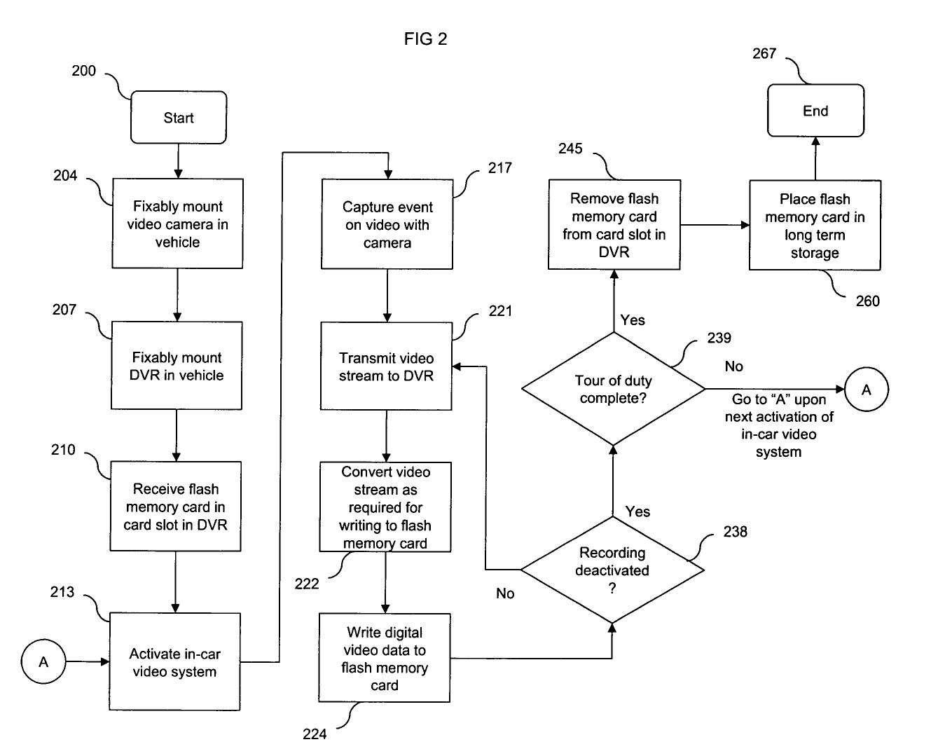

Turning now to FIG. 2, there is shown a flowchart illustrating a method of operating an in-car video system in accordance with the invention. The method starts at block 200. At block 204, a video camera (e.g., 150 in FIG. 1) is mounted in a vehicle in which an in-car video system is to be installed. In a similar manner, a digital video recorder is mounted in the vehicle as indicated by block 207. In some applications of the invention, it may be advantageous to position a digital video recorder having a small form factor package so that it is mounted substantially within a dashboard area of the vehicle. For example, as noted above, this area could be the area of the vehicle's dashboard where a factory-installed radio or sound system would normally be located. Such mounting, which is enabled by the invention as described herein, places the digital video recorder and digital recording medium (i.e., the flash memory card) in a direct operative relationship with a user seated in the front seat of the vehicle.

The method continues in block 210 in FIG. 2 where a user places a memory card into a flash memory receiving slot within the digital video recorder. Such a slot is configured to receive a desired flash memory card type and operably couples the flash memory to the digital video recorder. Thus, the flash memory can be accessed as a digital storage medium by the digital video recorder. The slot is typically configured to allow the flash memory card to readily inserted and released with light finger pressure. In some applications of the invention, a plurality of slots may be provided to accommodate different flash memory types (e.g., one slot may accept a CompactFlash card while another slot may accept a Secure Digital card). Alternatively, multiple slots that accept cards of the same format may be provided. In both cases, a digital video recorder configured to be operably coupled to multiple flash memory cards supplies more overall video storage space (where video is written to one flash memory card after another card is filled to capacity in a sequential manner) or allows a redundant (i.e., failsafe) operation where multiple copies of the same video recording are stored on separate flash memory cards.

At block 213, upon activation of the in-car video system (via automatic operation through the activation of the vehicle's emergency lights, for example, or via manual activation by a user, video is captured by the video camera and transmitted to the digital video recorder. These steps are indicated in blocks 217 and 221, respectively, in FIG. 2. The incoming video stream is converted to an appropriate format for recording onto the flash memory card at block 222. In some cases, the video stream is in an analog format and an analog to digital conversion would need to be performed, accordingly. In other cases where the incoming video stream is in digital format, some signal processing or conversion may be desired or required to access and write to the flash memory in an effective manner. The amount and type of signal processing or conversion required is dependent on the specific application of the invention and the necessary implementation of such techniques will be readily appreciated by those skilled in the art.

At block 224, digital data that is representative of the event captured by the camera at block 217 is written to the flash memory card. If the in-car video system is still activated, and the digital video recorder still recording, then a decision block 238 control is passed back to block 221 and the above described process of video capture and writing data to the flash memory at blocks 222 and 224 continues in an iterative manner. A video record of the event is thereby created and stored on the flash memory card.

Once the digital video recorder is deactivated, for example when an event or incident of interest is over, then at decision block 239 the method is paused until such time that another in-car system activation occurs (at block 213). If the user's tour of duty is over (e.g., a police officer has finished his or her shift), then as indicated by block 245, the flash memory card would be typically removed from its slot in the digital video recorder. The user then transports the flash memory as a removable digital storage medium and, as indicated by block 260, the user places the flash memory card into long term storage. At that point, the video recordings can be archived on the same flash memory cards used in the in-car video system, or transferred to other storage media such as CDs or DVDs in a conventional manner. The method ends at block 267 in FIG. 2.

Other features of the invention are contained in the claims that follow.

1. An in-car video system, comprising:
a video camera fixably mounted to a vehicle for capturing an image of an event and producing a corresponding video stream;
a digital video recorder fixably mounted to the vehicle, the digital video recorder having a receiving area being adapted to operably couple a flash memory card to the digital video recorder so that the flash memory functions as a digital video storage medium; and
a controller coupled to the video recorder to control writing of data that is representative of the video stream to a flash memory to thereby generate a stored video record of the event.

2. The in-car video system of claim 1 where the receiving area is further adapted so that the flash memory card is removably couplable to the digital video recorder.

3. The in-car video system of claim 1 where the flash memory is a flash memory card selected from the group consisting of Smart Media, Secure Digital, Multimedia Card, xD-Picture Card and Memory Stick.

4. The in-car video system of claim 1 where the flash memory is a CompactFlash card.

5. The in-car video system of claim 1 where the digital video recorder and controller are integrally packaged and sized to fit substantially within a standard single DIN sized radio opening.

6. The in-car video system of claim 1 where the digital video recorder and controller are integrally packaged and sized to fit substantially within a standard 1.5 DIN sized radio opening.

7. The in-car video system of claim 1 where the digital video recorder and controller are integrally packaged and sized to fit substantially within a standard double DIN sized radio opening.

8. The in-car video system of claim 1 where the digital video recorder and controller are integrally packaged and sized to fit substantially within a factory-sized radio opening of a production vehicle having a police package option.

9. A method of creating a video recording of an event, the method comprising the steps of:
providing a digital video recorder and video camera that are fixably mounted in a vehicle;
capturing video of the event using the car-mounted camera;
transmitting the video to the digital video recorder;
converting the video to a form that is writable to a flash memory, the flash memory being operably coupled to the digital video recorder; and
writing the converted video to the flash memory using the digital video recorder to thereby store a video record of the event on the flash memory.

10. The method of claim 9 including a step of controlling the digital video controller so that video is written to the flash memory automatically upon activation of the vehicle's emergency systems including emergency lights.

11. The method of claim 26 further including a step of providing a plurality of flash memory cards for storage within the vehicle so that when a first flash memory card in the plurality of flash memory cards is filled to capacity, a second flash memory card in the plurality of flash memory cards may be used to replace the first flash memory card.

12. In a vehicle-mounted video system including a car-mounted camera, a method of operating a digital video recorder, the method comprising the steps of:
receiving a flash memory card in a receiving area of the digital video recorder, the receiving area being adapted to operably couple the flash memory card to the digital video recorder so that the flash memory functions as a digital video storage medium;
receiving a video stream of an event captured by the camera;
converting the video stream to a form that is writable to the flash memory;
writing the converted video stream to the flash memory to thereby store a record of the event on the flash memory.

13. The method of claim 12 further including a step of reading the stored record from the flash memory.

14. The method of claim 13 further including a step of transmitting the record read from the flash memory to a remote monitor.

15. The method of claim 12 further including a step of removing the flash memory from the video recorder.

16. The method of claim 15 further including a step of storing the removed flash memory.

17. The method of claim 12 further including a step of fixably positioning the digital video recorder substantially within a dashboard area of the vehicle so that the digital video recorder is in a direct operative relationship with a user seated in the front seat of the vehicle.

18. The method of claim 17 where the dashboard area comprises a dashboard portion that is typically used to house a sound system.

19. The method of claim 18 where the dashboard portion is double DIN sized.

20. The method of claim 12 further including a step of receiving a second flash memory card in a receiving area of the digital video recorder, the receiving area being adapted to operably couple the flash memory card to the digital video recorder so that the second flash memory functions as a second digital video storage medium that automatically stores a portion of the video stream once the other flash memory card becomes full.
